(19) United States
(12) Patent Application Publication
(10) Pub. No.: US 2021/0136700 A1
(43) Pub. Date: May 6, 2021

(54) DYNAMIC OPTIMIZATION OF TRANSMITTER POWER OUTPUT (TPO) IN PORTABLE WIRELESS DEVICES

(71) Applicant: International Business Machines Corporation, Armonk, NY (US)

(72) Inventors: Omer Arad, Haifa (IL); Lior Limonad, Nesher (IL); Aviad Sela, Yokneam (IL); Valentin Dashinsky, Nahariya (IL)

(21) Appl. No.: 16/667,922

(22) Filed: Oct. 30, 2019

(51) Int. Cl. H04W 52/28; H04W 64/00; H04W 52/36

(52) U.S. Cl. CPC H04W 52/283; H04W 88/08; H04W 52/36; H04W 64/00

(57) ABSTRACT

Presented herein are devices, methods and software products for dynamically adjust a Transmitter Power Output (TPO) of a mobile wireless device's transmitter by computing a first geolocation of the mobile wireless device based on geolocation data received by the mobile wireless device, obtaining proximity attribute(s) of fixed location wireless access point(s) comprising at least a predefined second geolocation of the respective wireless access point, computing a minimal TPO value for the transmitter according to a distance between the first geolocation and the second geolocation of each wireless access point located within a transmission range of a transmitter of the mobile wireless device, selecting a preferred wireless access point requiring a lowest minimal TPO value and adjusting the TPO of the transmitter to the lowest minimal value. Wherein the minimal TPO value is sufficient for the respective wireless access point to reliably receive each message transmitted by the transmitter.

### BACKGROUND

The present invention, in some embodiments thereof, relates to optimize TPO of a mobile (portable) wireless device, and, more specifically, but not exclusively, to optimize TPO of a mobile wireless device by dynamically adjusting the TPO according to proximity attributes of one or more fixed location wireless access points.

Wireless communication such as, for example, cellular communication, Wireless Local Area Networks (WLAN), Long Range (LoRa) communication, Radio Frequency (RF) communication and/or the like has become a major component in many systems, platforms and applications, for example, telecommunication, data transfer, media consumption and many more.

Relying on wireless communication is massively enhanced with recent major advancements and evolution of Internet of Things (IoT) devices, for example, sensors, controllers and/or the like for in deployed for a plurality of various applications ranging from agriculture equipment, climate monitoring and prediction sensory systems, through smart cities and autonomous vehicles to consumer applications and military uses.

A large portion of the wireless devices used in such applications, in particular in the IoT arena may be battery powered with limited energy which are therefore designed and directed for reduced power consumption in order to preserve energy, extend battery life and increase reliability. Moreover, a growing number of these wireless device are mobile wireless devices, for example, carried devices, wearable devices, vehicle mounted devices and/or the like for which the challenge of preserving power is even greater. Especially when using and monitoring life-saving equipment or biometric data.

### SUMMARY

According to a first aspect of the present invention there is provided a mobile wireless device configured to dynamically adjust its Transmitter Power Output (TPO), comprising one or more circuitries configured to:
Compute a first geolocation of the mobile wireless device based on geolocation data received by the mobile wireless device.
Obtain one or more proximity attributes of one or more fixed location wireless access points. The proximity attribute(s) comprising at least a predefined second geolocation of the respective wireless access point.
Compute a minimal TPO value for the transmitter according to a distance between the first geolocation and the second geolocation of each wireless access point located within a transmission range of a transmitter of the mobile wireless device. The minimal TPO value is sufficient for the respective wireless access point to reliably receive each message transmitted by the transmitter.
Select a preferred wireless access point requiring a lowest minimal TPO value.
Adjust the TPO of the transmitter to the lowest minimal value.

According to a second aspect of the present invention there is provided a method of dynamically adjusting Transmitter Power Output (TPO) of a mobile wireless device, comprising:
Computing a first geolocation of the mobile wireless device based on geolocation data received by the mobile wireless device.
Obtaining one or more proximity attributes of one or more fixed location wireless access points. The proximity attribute(s) comprising at least a predefined second geolocation of the respective wireless access point.
Computing a minimal TPO value for the transmitter according to a distance between the first geolocation and the second geolocation of each wireless access point located within a transmission range of a transmitter of the mobile wireless device. The minimal TPO value is sufficient for the respective wireless access point to reliably receive each message transmitted by the transmitter.
Selecting a preferred wireless access point requiring a lowest minimal TPO value.
Adjusting the TPO of the transmitter to the lowest minimal value.

According to a third aspect of the present invention there is provided a computer program product for dynamically adjusting Transmitter Power Output (TPO) of a mobile wireless device, comprising a non-transitory computer readable storage medium and:
First program instructions to compute a first geolocation of the mobile wireless device based on geolocation data received by the mobile wireless device.
Second program instructions to obtain one or more proximity attribute of one or more fixed location wireless access point, the one or more proximity attribute comprising at least a predefined second geolocation of the respective wireless access point.
Third program instructions to compute a minimal TPO value for the transmitter according to a distance between the first geolocation and the second geolocation of each wireless access point located within a transmission range of a transmitter of the mobile wireless device, the minimal TPO value is sufficient for the respective wireless access point to reliably receive each message transmitted by the transmitter.
Fourth program instructions to select a preferred wireless access point requiring a lowest minimal TPO value.
Fifth program instructions to adjust the TPO of the transmitter to the lowest minimal value;
   wherein the first, second, third, fourth and fifth program instructions are executed by one or more processor of the mobile wireless device from the non-transitory computer readable storage medium.

In a further implementation form of the first, second and/or third aspects, the geolocation data used by the circuitry to compute the first geolocation is received from one or more location sensors of the mobile wireless device.

In a further implementation form of the first, second and/or third aspects, the geolocation data used by the circuitry to compute the first geolocation is extracted from a plurality of beacon messages received from a plurality of beacon transmitting devices.

In a further implementation form of the first, second and/or third aspects, one or more of the proximity attribute are predefined in the mobile wireless device.

In a further implementation form of the first, second and/or third aspects, one or more of the proximity attribute are received by the circuitry in one or more messages transmitted by one or more wireless devices configured to broadcast the second geolocation.

In an optional implementation form of the first, second and/or third aspects, the proximity attributes further comprising obstacle information relating to one or more obstacles blocking at least partially a Line of Sight (LOS) transmission path between the mobile wireless device and the respective wireless access point.

In an optional implementation form of the first, second and/or third aspects, the minimal TPO value is adjusted to overcome transmission degradation induced by one or more of the obstacles.

In an optional implementation form of the first, second and/or third aspects, the minimal TPO value is adjusted according to selection of the preferred wireless access point based on aggregation of the distance and the transmission degradation induced by one or more of the obstacles with respect to each of a plurality of wireless access points located in the transmission range of the transmitter.

In an optional implementation form of the first, second and/or third aspects, the minimal TPO value is dynamically adjusted according to one or more changes of the first geolocation of the mobile wireless device identified according to newly received geolocation data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of adjusting TPO of a mobile wireless device according to proximity attributes of one or more fixed location access points, according to some embodiments of the present invention; and

FIG. 2 is a schematic illustration of an exemplary wireless environment in which TPO of a mobile wireless device is adjusted according to proximity attributes of one or more fixed location access points, according to some embodiments of the present invention; and

FIG. 3 presents exemplary wireless environments in which TPO of a mobile wireless device is adjusted according to obstacles blocking a transmission path between the mobile wireless device and a preferred wireless access point, according to some embodiments of the present invention.

### DETAILED DESCRIPTION

The present invention, in some embodiments thereof, relates to optimize TPO of a mobile (portable) wireless device, and, more specifically, but not exclusively, to optimize TPO of a mobile wireless device by dynamically adjusting the TPO according to proximity attributes of one or more fixed location wireless access points.

According to some embodiments of the present invention, there are provided methods, systems and computer program products for optimizing TPO of a mobile wireless device's transmitter according to one or more proximity attributes of a preferred wireless access point selected from one or more wireless access points located in fixed and predetermined geographical locations within a transmission range of the transmitter. In particular, the TPO is adjusted according to the proximity attribute(s) of the preferred wireless access point to a minimal value sufficient for the preferred wireless access point to reliably and efficiently receive messages transmitted by the mobile wireless device.

The mobile wireless device may include, for example, a carried wireless device (e.g. mobile phone, tablet, mobile computer, etc.), a wearable wireless device carried by a user (e.g. person, pet, livestock animal, wildlife animal, etc.) a wireless device mounted in a vehicle (e.g. drone, ground vehicle, naval vehicle, etc.), an IoT wireless device (e.g. sensor, controller, etc.).

The mobile wireless device having the transmitter and optionally a receiver may connect to one or more wireless networks, for example, a cellular network, a LoRa network, a Wireless Local Area Network (WLAN) (e.g. Wi-Fi) and/or the like in order to communicate with one or more remote network resources, for example, a server, a cluster of computing nodes, a cloud computing platform and/or the like providing one or more services to the mobile wireless device.

As the mobile wireless device is mobile and may change its location, the geolocation (geographical location) of the mobile wireless device may frequently, continuously and/or periodically change with respect to one or more wireless access points, for example, a gateway, a router, a base station, a cell tower and/or the like deployed in fixed and predefined (known) locations to provide network connectivity to mobile wireless devices.

It is possible for the mobile wireless device to adjust its transmitter such that it constantly transmits at maximum TPO to ensure reception of its transmitted messages at one or more of the fixed location wireless access points. However, very frequently such maximal TPO may be superfluous since the mobile wireless device may transmit messages using a significantly reduced TPO which may be still reliably received by one or more of the wireless access points, in particular by the preferred wireless access point.

Such scenarios may include, for example, cases where the distance of the mobile wireless device to one or more of the wireless access points, in particular to a nearest wireless access point is significantly shorter than the maximum transmission range (coverage area) of the transmitter of the mobile wireless device thus a significantly reduced TPO may be sufficient for reliable transmission. The TPO may be adjusted according to the distance to the nearest wireless access point, in particular when the direct Line of Sight (LOSO transmission path between the mobile wireless device and the nearest wireless access point is open and clear of obstacles. In other scenarios, even if the LOS transmission path between the mobile wireless device and one or more of the wireless access points is blocked or partially blocked by one or more obstacles, the TPO value required for the transmitter to transmit messages reliably received by these wireless access point(s) may still be significantly lower than the maximum TPO.

In order to optimize the TPO value of its transmitter, specifically reduce the TPO value, the mobile wireless device may adjust the TPO according to the proximity attributes of one or more of the fixed location wireless access points with respect to a (current) location of the mobile wireless device, specifically those wireless access points located within the transmission range of the mobile wireless device's transmitter.

The mobile wireless device may obtain and/or compute its own (first) geolocation, for example, based on geolocation data received from one or more location sensors of the mobile wireless device, for example, a Global Positioning System (GPS) sensor, a ranging sensor and/or the like. In another example, the mobile wireless device may compute the first (its own) geolocation based on geolocation data received from one or more other wireless devices, for example, fixed beacon transmitting devices located in fixed (static) geolocations and configured to broadcast geolocation data, for example, their own static geolocations.

The mobile wireless device may further obtain the proximity attribute(s) of one or more of the wireless access points located in fixed and predefined locations, specifically those wireless access points which are located within the transmission range (coverage area) of the mobile wireless device's transmitter. The proximity attributes of the fixed location wireless access point(s) may be locally stored in the mobile wireless device and/or the mobile wireless device may obtain the geolocation(s) data from one or more wireless devices configured to broadcast these predefined geolocation(s).

The proximity attributes of each fixed location wireless access point may include at least a (second) geolocation of the respective wireless access point.

The mobile wireless device may compute its distance to each wireless access point based on the first geolocation and the second geolocation of the respective wireless access point extracted from the proximity attribute(s) of the respective wireless access point.

For each wireless access point, the mobile wireless device may further compute a minimal TPO value of the mobile device's transmitter according to the distance computed for the respective wireless access point which is sufficient for the respective wireless access point to reliably receive messages (transmission) transmitted by the transmitter. The mobile wireless device may compute the TPO value of its transmitter as known in the art based on transmission parameters, for example, frequency spectrum, modulation scheme, susceptibility to noise and/or interference and/or the like typical to the wireless network and/or protocols used by the mobile wireless device.

The mobile wireless device may then select a preferred wireless access point for which the lowest minimal TPO value is required to reliably receive the transmission of the mobile wireless device's transmitter.

In case only a single wireless access point is located within the transmission range of its transmitter, the mobile wireless device may select this single wireless access point as the preferred wireless access point. However, in case there are multiple wireless access points available within the transmission range of the its transmitter, the mobile wireless device may select the preferred wireless access point from the plurality of available wireless access points according to the lowest minimal TPO value. Naturally, in case of no obstacles blocking the LOS transmission path between the mobile wireless device and each of the plurality of wireless access points, for example, a rural open area, the mobile wireless device may select the nearest wireless access point as the preferred wireless access point since it may the shortest distance may require the least TPO value for the transmitter.

The mobile wireless device may then adjust the TPO of its transmitter to the minimal TPO value computed for the preferred wireless access point to enable reliable transmission at least to the preferred wireless access point

However, the proximity attributes of one or more of the wireless access points may further include one or more additional attributes, for example, obstacles information relating to one or more obstacles which may potentially block at least partially the direct LOS transmission path between the mobile wireless device and the respective wireless access point. The proximity attributes relating to each obstacle may include, for example, a description of the obstacle, a size of the obstacle, a height of the obstacle, a material of the obstacle, material(s) composing the obstacle and/or the like.

The mobile wireless device may therefore further adjust the TPO value of its transmitter to compensate for transmission degradation induced by one or more fixed and predefined (known) obstacles located between the mobile wireless device and one or more of the wireless access point which may at least partially block the LOS transmission path between the mobile wireless device and the respective wireless access point. The mobile wireless device may extract the information relating to the obstacles, for example, from the proximity attributes of one or more of the wireless access points which may describe obstacles located in their vicinity. In another example, the mobile wireless device may extract the obstacles information relating to the obstacles from one or more global proximity data sources, for example, a map, a list and/or the like which may be associated with one or more of the wireless access points according to their respective (second) geolocations, specifically with respect to the current (first) geolocation of the mobile wireless device.

In the case of the single wireless access point available within the transmission range of transmitter of the mobile wireless device, based on the geolocation of the obstacle(s) with respect to the first geolocation (current location of the mobile wireless device) and the second geolocation of the single wireless access point, the mobile wireless device may determine whether the obstacle(s) block at least partially the LOS transmission path to the single wireless access points thus potentially degrading the transmission of the mobile wireless device to the single wireless access point. In case the mobile wireless device determines that the obstacle(s) may degrade its transmission, the mobile wireless device may adjust, specifically increase the TPO value and adjust its transmitter accordingly to overcome the transmission degradation induced by the obstacle(s).

In case there are multiple wireless access points available within the transmission range of the mobile wireless device's transmitter, the mobile wireless device may select the preferred wireless access point from the plurality of available wireless access points according to the minimal TPO values computed for each of the plurality of available wireless access. The mobile wireless device may compute these minimal TPO values which are required for the transmitter to transmit messages that are reliably received by at least some of the plurality of wireless access points by aggregating the distance to each wireless access points and the estimated transmission degradation induced by blocking obstacle(s) which may block the transmission path between the mobile wireless device and the respective wireless access point. The mobile wireless device may then select the preferred wireless access point to be the wireless access point requiring the minimal aggregated TPO value. The mobile wireless device may then adjust the TPO of the transmitter to the computed lowest minimal aggregated TPO value.

As the mobile wireless device may move and change its location, the mobile wireless device may dynamically adjust the TPO of its transmitter according to changes identified in the geolocation of the mobile wireless device with respect to the geolocation(s) of the wireless access point(s), specifically those wireless access points which are nearby and within the transmission range of the mobile wireless device. Moreover, since the location changes of the mobile wireless device may bring one or more obstacles to block the at least partially the transmission path between the mobile wireless device and one or more of the wireless access points, the mobile wireless device may dynamically adjust the TPO of its transmitter to overcome potential transmission degradation induced by the newly blocking obstacle(s).

The distance based TPO optimization may present major advantages and benefits compared to existing methods and systems for optimizing the TPO.

First, by optimizing the TPO of the mobile wireless device's transmitter, specifically reducing the TPO to a minimal value sufficient for the preferred wireless access point to reliably receive messages transmitted by the mobile wireless device, the power consumption of the transmitter may be significantly reduced since frequently setting the TPO to its maximum value may be superfluous and unnecessary. The transmitter may be a major power consumer of the mobile wireless device and reducing its power may therefore significantly reduce the overall power consumption of the mobile wireless device. This may be of extreme benefit in particular for low-end mobile wireless devices, for example, IoT devices and/or the like which are battery powered and reducing the device's power consumption may preserve energy thus significantly extending battery life of the mobile wireless devices.

Moreover, some of the existing methods may apply TPO optimization based on messages exchanged (handshake) between the mobile wireless device and the wireless access point(s) to provide channel and/or transmission feedback information, for example, Received Signal Strength Indicator (RSSI) and/or the like. As the mobile wireless device may frequently change its location, this feedback messaging may be extensive thus extremely power consuming which may significantly reduce the battery life of the mobile wireless device. In contrast, since the distance based TPO optimization is based on the mobile wireless device computing the TPO according to the proximity attribute(s)of the wireless access point(s), no channel status feedback communication is required with the wireless access point(s) thus significantly reducing the power consumption of the transmitter and hence of the mobile wireless device.

Furthermore, some of the existing methods may require the mobile wireless device to constantly transmit (query) messages in attempt to identify the wireless access point(s) in order to establish a network connection with them. In case there are no wireless access points within the transmission range of the mobile wireless device's transmitter these query transmissions are useless and may superfluously consume power. On the other hand, the mobile wireless device applying the proximity attributes based TPO optimization may disable its transmitter whenever it identifies that no close-by wireless access point(s) is available thus further reducing the power consumption of the transmitter and hence reducing the overall power consumption of the mobile wireless device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

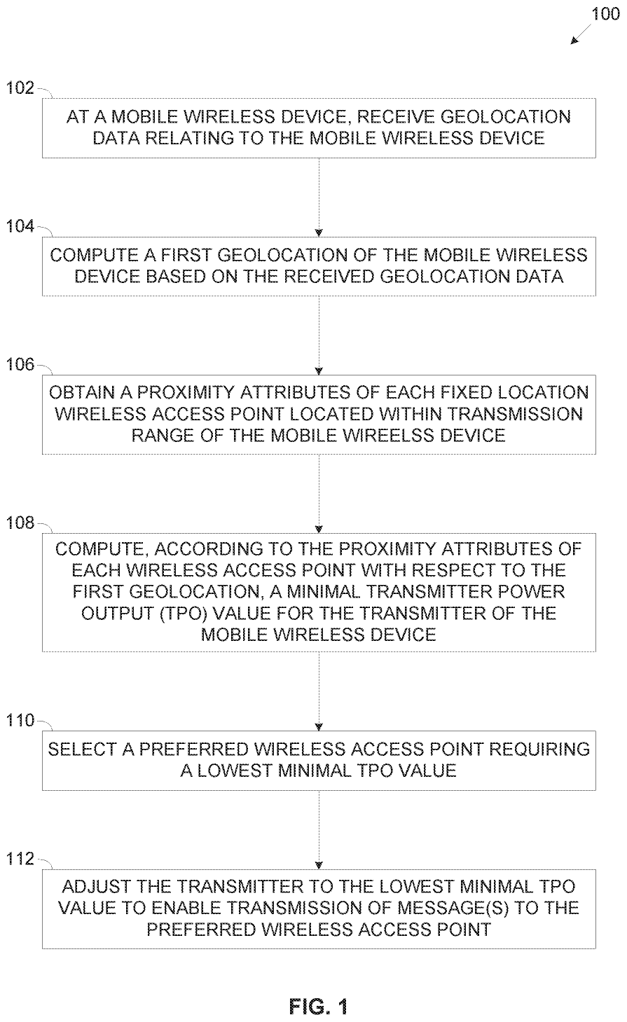

Referring now to the drawings, FIG. 1 is a flowchart of an exemplary process of adjusting TPO of a mobile wireless device according to proximity attributes of one or more fixed location access points, according to some embodiments of the present invention. An exemplary process 100 may be executed by a mobile wireless device to adjust a TPO value of its wireless transmitter according to one or more proximity attributes of one or more wireless access point, specifically wireless access point which are located in fixed geographical locations (geolocations) within a transmission range of the wireless transmitter.

In particular, the mobile wireless device adjusts the TPO to optimize the TPO value to a minimal value which is sufficient for a preferred wireless access point selected according to its proximity attribute(s) to reliably receive messages transmitted by the mobile wireless device.

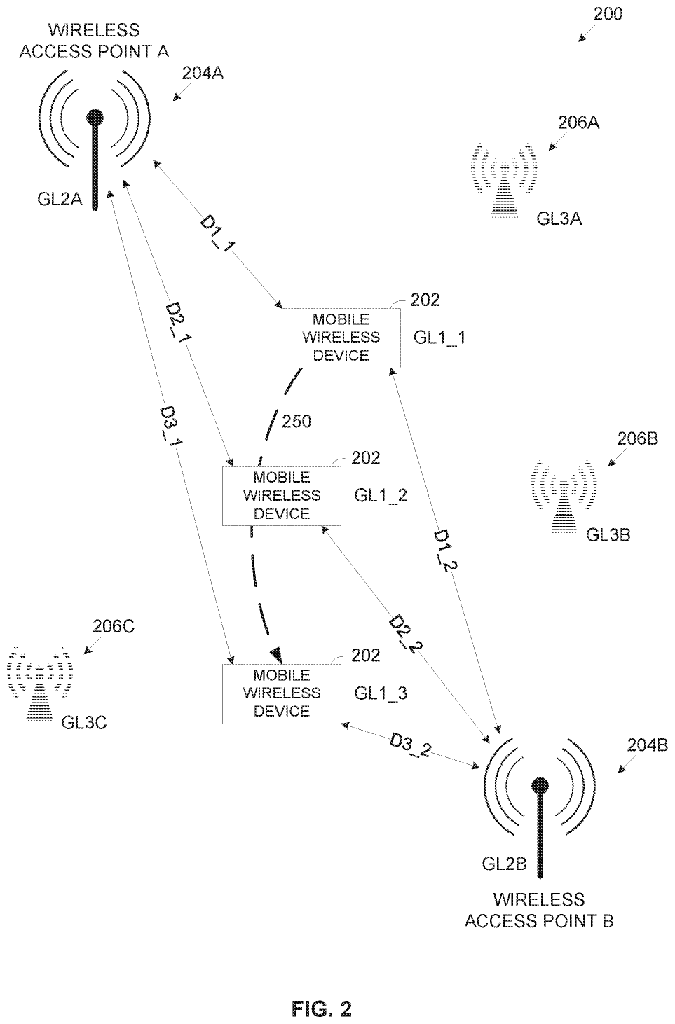

Reference is also made to FIG. 2, which is a schematic illustration of an exemplary wireless environment in which TPO of a mobile wireless device is adjusted according to proximity attributes of one or more fixed location access points, according to some embodiments of the present invention. An exemplary wireless environment 200, for example, a cellular network environment, a LoRa network environment, a WLAN environment (e.g. Wi-Fi) and/or the like may include infrastructure network equipment configured to provide wireless network connectivity to one or more wireless devices, in particular mobile wireless devices 202 which may dynamically move (travel) such that they may change their geolocation (geographical location) in the wireless environment 200.

The wireless environment 200 may encompass various sizes of geographical areas and locations according to the wireless technology (e.g. cellular, LoRa, WLAN, etc.) supported by the infrastructure network equipment deployed in the wireless environment 200. The wireless environment 200 may therefore range from relatively small indoor spaces, through urban areas to large open rural areas.

The infrastructure network equipment comprising one or more wireless access points 204, for example, a gateway, a router, a base station, a cell tower and/or the like may typically connect to one or more backbone networks connecting to one or more remote network resources, for example, a server, a cluster of computing nodes, a cloud computing platform and/or the like providing one or more services to the mobile wireless device 202.

The mobile wireless device 202 may include, for example, a carried wireless device such as, for example, a mobile phone, a tablet, a mobile computer and/or the like. In another example, the mobile wireless device 202 may include a wearable wireless device carried by a user, for example, a human, a pet, a livestock animal, a wildlife animal and/or the like. In another example, the mobile wireless device 202 may include a wireless device mounted in a vehicle, for example, a drone, a ground vehicle, a naval vehicle and/or the like. In another example, the mobile wireless device 202 may include an IoT wireless device, for example, a sensor, a controller and/or the like which may frequently change its geolocation. For example, an IoT sensor deployed in a water body (e.g. river, lake, pool, reservoir, etc.) may float, drift and/or otherwise change its location in the water body.

As the mobile wireless device 202 may dynamically move (travel) in the wireless environment 200, the geolocation of the mobile wireless device 202, which may be expressed by planar and elevation coordinates according to one or more coordinate systems as known in the art, may change accordingly. For example, a certain mobile wireless device 202 may travel in the wireless environment 200 along a path 250. Initially the mobile wireless device 202 is located at geolocation GL1_1. The mobile wireless device 202 may gradually advance along the path 250 to geolocation GL1_2 and may finally advance to geolocation GL1_3.

The wireless access points 204 on the other hand are typically statically deployed in the wireless environment 200 such that they are located at fixed and predefined geolocations. For example, a wireless access point 204A may be located at geolocation GL2A and a wireless access point 204B may be located at geolocation GL2B.

Optionally, a plurality of beacon transmitting devices 206 are statically deployed in fixed and predefined locations the wireless environment 200. The beacon transmitting devices 206 are wireless devices configured to transmit beacon messages comprising geolocation data, for example, their fixed geolocation, their unique identifier (ID) and/or the like. Using the geolocation data extracted from intercepted beacon messages, one or more devices employing one or more methods and/or techniques as known in the art, for example, triangulation and/or the like to compute their own geolocation according to their relative location with respect to at least some of the beacon transmitting devices 206 whose beacon messages are intercepted. The beacon transmitting devices 206 may typically transmit their beacon messages periodically every predefined period of time, for example, 100 ms (milliseconds), 0.5 second, 1 second and/or the like. For example, a beacon transmitting devices 206A may periodically transmit beacon messages comprising its geolocation GL3A, a beacon transmitting devices 206B may periodically transmit beacon messages comprising its geolocation GL3B and a beacon transmitting devices 206C may periodically transmit beacon messages comprising its geolocation GL3C.

Optionally, one or more of the beacon transmitting devices 206 are integrated in respective wireless access points 204 such that the wireless access points 204 may transmit the beacon messages comprising the geolocation of the respective wireless access points 204. For example, the wireless access point 204A also serving as a beacon transmitting devices 206 may periodically transmit beacon messages comprising its geolocation GL2A. In another example, the wireless access point 204B also serving as a beacon transmitting devices 206 may periodically transmit beacon messages comprising its geolocation GL2B.

The mobile wireless device 202 may comprise a transmitter for transmitting one or more messages to one or more of the wireless access points 204 which may typically transfer the messages received from mobile wireless device 202 to one or more of the service providing remote network resources. The mobile wireless device 202 may further include a receiver for receiving one or more messages transmitted in the transmission environment 200. For example, using its receiver, the mobile wireless device 202 may receive one or more messages from one or more of the wireless access points 204. These received messages may typically originate from one or more of the service providing remote network resources and are relayed to the mobile wireless device 202 by the wireless access point(s) 204. In another example, the mobile wireless device 202 may receive one or more messages from one or more of the beacon transmitting devices 206, in particular the beacon messages which may be used by the mobile wireless device 202 to compute its (current) location.

The mobile wireless device 202 may further include one or more processors and memory resources, for example, volatile memory (e.g. RAM) and/or persistent non-volatile memory (e.g. ROM, Flash, solid state media, etc.) for data and/or program store. The processor(s) may execute one or more software modules, for example, a process, an application, an agent, a utility, a tool, a script and/or the like each comprising a plurality of program instructions which may be executed by the processor(s) from the program store. The mobile wireless device 202 may further include one or more hardware elements, for example, a circuit, a component, an Integrated Circuit (IC), an Application Specific Integrated Circuit (ASIC), a Field Programmable Gate Array (FPGA), a Digital Signals Processor (DSP), a network processor and/or the like.

The mobile wireless device 202 may thus execute, utilize, implement and/or facilitate the process 100 using one or more of the hardware elements, one or more software modules and/or a combination thereof.

The process 100 and the transmission environment 200 describe a single mobile wireless device 202. This, however, should not be construed as limiting since the process 100 may be executed by a plurality of mobile wireless devices 202 located in the transmission environment 200 to adjust the TPO of their respective transmitters for transmitting messages to one or more of the wireless access points 204.

As shown at 102, the process 100 starts with the mobile wireless device 202 receiving geolocation data, in particular geolocation data which may be used by the mobile wireless device 202 to compute its geolocation GL1. The mobile wireless device 202 may receive the geolocation data from one or more sources, devices and/or services. For example, the mobile wireless device 202 may receive geolocation data from one or more location sensors associated (e.g. integrated, mounted, attached, etc.) with the mobile wireless device 202, for example, a GPS sensor, a ranging sensor (e.g. camera, RADAR, LiDAR, ultrasonic sensor, etc.) configured to measure distances to known location objects and/or the like. In another example, the mobile wireless device 202 may extract the geolocation data from a plurality of beacon messages received from at least some of the beacon transmitting devices 206.

As shown at 104, the mobile wireless device 202 may compute a (first) geolocation of the mobile wireless device 202 itself according to the received geolocation data. The computation of the first geolocation naturally depends on the type and source of the geolocation data.

For example, in case the geolocation data is received from one or more of the location sensor(s), for example, the GPS sensor, the geolocation data may include coordinates of the current location of the GPS sensor and hence of the mobile wireless device 202. The mobile wireless device 202 may thus compute the first geolocation based on the coordinates extracted from the geolocation data received from the GPS sensor. In another example, in case the geolocation data is received from the ranging sensor(s), the geolocation data may include, for example, angles and/or distances to multiple objects (e.g. building, monument, natural object, etc.) detected and identified based on analysis of sensory data captured by the ranging sensor(s). The mobile wireless device 202 may apply one or more techniques as known in the art, for example, triangulation and/or the like to compute the first geolocation based on the relative location of the detected objects which is predefined and known to the mobile wireless device 202. The location of the detected objects may be obtained from one or more sources. For example, the location of one or more of the detected objects may be locally stored in the mobile wireless device 202, for example, a map with objects designation, a list associating objects (typically objects visual and/or textual description) with their geolocations and/or the like. In another example, the mobile wireless device 202 may receive the geolocations of the detected objects from one or more wireless devices, for example, the wireless access point 204, the beacon transmitting device 206, another mobile wireless device 202 and/or the like which is configured to broadcast the geolocation of one or more of the detected objects associated with a description of the respective detected object.

In another example, in case the geolocation data is received from the beacon transmitting devices 206, the geolocation data extracted from the beacon messages may include, for example, coordinates of the fixed geolocations of the respective beacon transmitting devices 206 which transmitted the beacon messages. In another example, the geolocation data extracted from the beacon message may include the unique IDs of the respective transmitting beacon transmitting devices 206. In such case, the mobile wireless device 202 may obtain associate each received beacon message with its respective beacon transmitting devices 206 according to one or more locally stored records, for example, a map, a list and/or the like which associates each unique ID with the fixed geolocation of the respective beacon transmitting device 206.

The mobile wireless device 202 may apply one or more techniques as known in the art, for example, triangulation and/or the like to compute the first geolocation based on a relative location with respect to the predefined and fixed location of at least some of the beacon transmitting devices 206 according to the reception angle of the beacon messages transmitted by the respective beacon transmitting devices 206.

As shown at 106, the mobile wireless device 202 may obtain one or more proximity attributes of one or more wireless access points 204, in particular, wireless access points 204 which are within the transmission range (coverage area) of the transmitter of the mobile wireless device 202. The proximity attributes of each wireless access point 204 may include at least a (second) geolocation of the respective wireless access point 204.

The mobile wireless device 202 may obtain the proximity attribute(s) of the wireless access point(s) 204 from one or more sources. For example, the mobile wireless device 202 may obtain the proximity attribute(s) from one or more records locally stored in the mobile wireless device 202 which comprise the proximity attribute(s) of one or more of the wireless access points 204. The locally stored record(s) may include, for example, a map with location designations of wireless access points 204, a list and/or a table listing the geolocation of wireless access points 204 optionally with a unique ID assigned to each wireless access point 204 and/or the like.

In another example, the mobile wireless device 202 may receive the proximity attribute(s) from one or more wireless devices, for example, the wireless access point 204, the beacon transmitting device 206, another mobile wireless device 202 and/or the like which are configured to broadcast the proximity attribute(s) of one or more of the wireless access points 204. In such case, the mobile wireless device 202 may extract the proximity attribute(s) from one or more messages received from the broadcasting wireless device(s). Additionally and/or alternatively, the mobile wireless device 202 may derive or infer one or more of the proximity attributes from data included in one or more of the messages received from the broadcasting wireless device(s).

For example, one or more of the wireless devices may be configured to periodically broadcast the geolocation of at one or more of the wireless access points 204. In another example, one or more of the wireless devices may be configured to broadcast the geolocation of one or more of the wireless access points 204 in response to a request received from one or more other wireless devices, for example, the mobile wireless device 202. In another example, one or more of the wireless devices may be configured to broadcast the geolocation of one or more of the wireless access points 204 when detecting presence and/or entrance of the mobile wireless device 202 in the wireless environment 200.

As shown at 108, for each of the wireless access points 204 which are within the transmission range (coverage area) of the transmitter of the mobile wireless device 202, the mobile wireless device 202 may compute the minimal TPO value required for the transmitter to transmit messages reliably received by the respective wireless access point 204 according to the proximity attribute(s) of the respective wireless access point 204.

In particular, the mobile wireless device 202 computes the minimal TPO value required for each wireless access point 204 according to the proximity attribute(s) of the respective wireless access point with respect to the first geolocation expressing the (current) location of the mobile wireless device 202. For example, the mobile wireless device 202 may compute the minimal TPO value according to a distance between the first geolocation of the mobile wireless device 202 and the second geolocation of the respective wireless access point 204.

The distance computed for each wireless access point 204 reflects an LOS length between the mobile wireless device 202 and the respective wireless access point 204 and may therefore express the shortest transmission path between the mobile wireless device 202 and the respective wireless access point 204. The LOS transmission path which is the shortest transmission path between the mobile wireless device 202 and the respective wireless access point 204 may therefore require the minimal TPO value for the transmitter to transmit messages reliably received by the respective wireless access point 204.

For example, assuming the mobile wireless device 202 is located at the (first) geolocation GL1_1, the mobile wireless device 202 may compute a distance D1_1 between the geolocation GL1_1 and the geolocation GL2A of the wireless access point 204A and a distance D1_2 between the geolocation GL1_1 and the geolocation GL2B of the wireless access point 204B. In another example, assuming the mobile wireless device 202 is located at the (first) geolocation GL1_2, the mobile wireless device 202 may compute a distance D2_1 between the geolocation GL1_2 and a distance D2_2 between the geolocation GL1_1 and the geolocation GL2B of the wireless access point 204B. In another example, assuming the mobile wireless device 202 is located at the (first) geolocation GL1_3, the mobile wireless device 202 may compute a distance D3_1 between the geolocation GL1_3 and the geolocation GL2A of the wireless access point 204A and a distance D3_2 between the geolocation GL1_1 and the geolocation GL2B of the wireless access point 204B.

Based on the distance computed to each wireless access point 204, the mobile wireless device 202 may compute the minimal TPO value required for reliably transmitting messages to the respective wireless access point 204, specifically via the respective LOS transmission path. The mobile wireless device 202 may compute the minimal TPO according to the computed distance based on transmission parameters (i.e. range, strength, etc.) typical to the transmission environment 200 using formulations as known in the art. Such transmission parameters may include for example, frequency spectrum, modulation scheme, susceptibility to noise and/or interference and/or the like.

Optionally, the proximity attributes of one or more of the wireless access points 204 includes information relating to one or more fixed obstacles which may potentially block at least partially the LOS transmission path between the mobile wireless device 202 and the respective wireless access point(s) 204.

The proximity attributes relating to each fixed location (static) obstacle may include a predefined and known geolocation of the respective obstacle and optionally one or more attributes of the respective fixed obstacle, for example, dimensions (e.g. size, height, etc.) of the respective obstacle, one or more material composing the respective obstacle and/or the like which may reflect one or more transmission blocking parameters of the respective obstacle.

The mobile wireless device 202 may obtain the proximity attributes relating to one or more obstacles from one or more sources. For example, the obstacles proximity attributes may be included with the proximity attributes of one or more of the wireless access points 204. In such case the mobile wireless device 202 may obtain the obstacles proximity attributes together with the proximity attributes of the respective wireless access point(s) 204, for example, from the locally stored record and/or from one or more wireless devices configured to broadcast the proximity attributes.

In another example, the mobile wireless device 202 may obtain the proximity attributes relating to one or more obstacles from one or more general geographical data records, for example, a map with obstacles designation, a list associating obstacles with their geolocations and/or the like. Such general geographical data record(s) may be locally stored in the mobile wireless device 202, for example, in a memory, a storage and/or the like. Optionally, the mobile wireless device 202 receives the geolocations of the obstacles from one or more wireless devices, for example, the wireless access point 204, the beacon transmitting device 206, another mobile wireless device 202 and/or the like which is configured to broadcast the proximity attributes relating to one or more of the obstacles which may potentially block at least partially the LOS transmission path between the mobile wireless device 202 and one or more of the wireless access points 204.

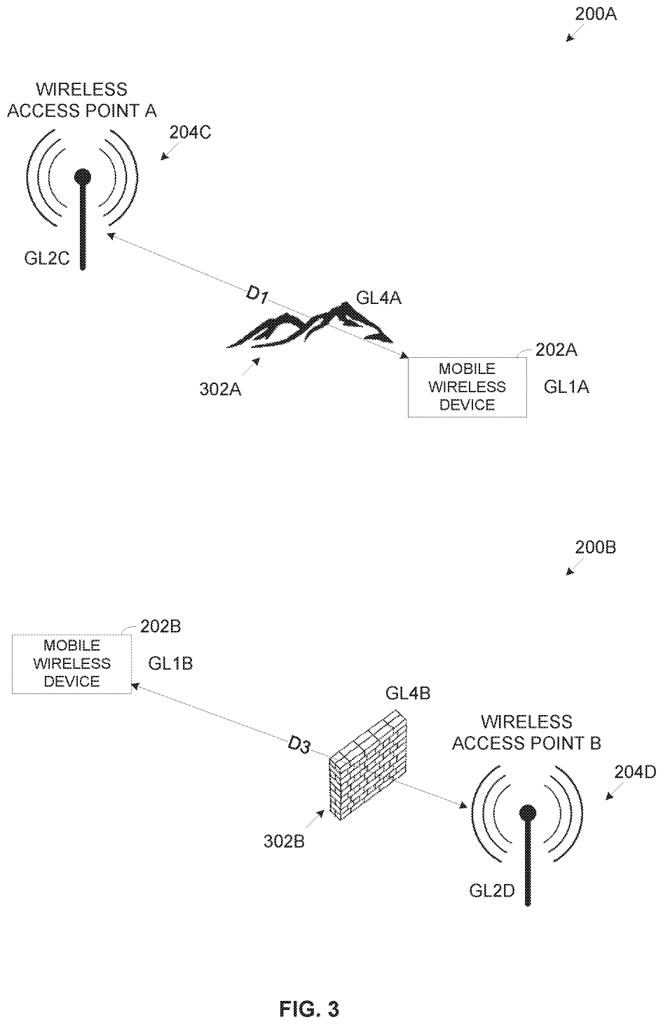

Reference is now made to FIG. 3, which presents exemplary wireless environment in which TPO of a mobile wireless device is adjusted according to obstacles blocking a transmission path between the mobile wireless device and a preferred wireless access point, according to some embodiments of the present invention. For example, an obstacle 302A, for example, a mountain ridge may be located between a mobile wireless device 202A such as the mobile wireless device 202 and a wireless access point 204C such as the wireless access point 204 in a wireless environment 200A such as the wireless environment 200, specifically an open area, for example, a rural area and/or the like. In another example, an obstacle 302B, for example, a wall may be located between a mobile wireless device 202B such as the mobile wireless device 202 and a wireless access point 204D such as the wireless access point 204 in a wireless environment 200B such as the wireless environment 200, specifically an urban area.

Reference is made once again to FIG. 1.

Optionally, the mobile wireless device 202 adjusts the minimal TPO value computed for one or more of the wireless access points 204 according to the distance between the mobile wireless device 202 and the respective wireless access point(s) 204. In particular, the mobile wireless device 202 may increase the minimal TPO value to overcome transmission degradation induced, caused and/or resulting from one or more obstacles which may potentially block at least partially the LOS transmission path between the mobile wireless device 202 and the respective wireless access point(s) 204.

The mobile wireless device 202 may determine whether one or more obstacles may at least partially block the LOS transmission path to the respective wireless access point 204 by analyzing the obstacles proximity attributes available for this obstacle(s) with respect to the respective wireless access point 204.

Based on the geolocation data of the obstacles, the mobile wireless device 202 may compute the location of the obstacle(s) relative to the first geolocation (of the mobile wireless device 202) and the second geolocation of each wireless access point 204 for which a respective minimal TPO value was computed. Based on the relative location, the mobile wireless device 202 may determine whether the obstacle(s) block the transmission path to the wireless access point 204 and to what extent (i.e. fully, partially, etc.). Based on this determination optionally coupled with one or more of the transmission blocking parameters of the blocking obstacle(s) if available, the mobile wireless device 202 may adjust, specifically increase the minimal TPO value computed for the respective wireless access point 204 to overcome the transmission degradation which may be induced by the blocking obstacle(s).

For example, in the exemplary transmission environment 200A, based on computation of a geolocation GL4A of the mountain ridge 302A with respect to a first geolocation GL1A of the mobile wireless device 202A and a second geolocation GL2C of the wireless access point 204C, the mobile wireless device 202A may determine that the mountain ridge 302A may block at least partially the transmission path between the mobile wireless device 202A and the wireless access point 204C thus potentially degrading transmission of the mobile wireless device 202A. The mobile wireless device 202A may therefore adjust the minimal TPO value computed for the mobile wireless device 202A, specifically increase the minimal TPO value in order to increase the energy of transmitted signals which may bypass the blocking mountain ridge 302A and be reliably received by the wireless access point 204C thus overcoming the transmission degradation induced by the blocking mountain ridge 302A.

In another example, in the exemplary transmission environment 200B, based on computation of a geolocation GL4B of the wall 302B with respect to a first geolocation GL1B of the mobile wireless device 202B and a second geolocation GL2D of the wireless access point 204D, the mobile wireless device 202B may determine that the wall 302B may block at least partially the transmission path between the mobile wireless device 202B and the wireless access point 204D thus potentially degrading transmission of the mobile wireless device 202B. The mobile wireless device 202B may therefore adjust the minimal TPO value computed for the mobile wireless device 202A, specifically increase the minimal TPO value in order increase the energy of transmitted signals which may penetrate through the blocking wall 302B and be reliably received by the wireless access point 204D thus overcoming the transmission degradation induced by the blocking wall 302B.

As shown at 110, the mobile wireless device 202 may select a preferred wireless access point 204 according to the minimal TPO value computed for each of the wireless access point 204 identified in the transmission range of the transmitter of the mobile wireless device 202. In particular, the mobile wireless device 202 may select the preferred wireless access point 204 to be the wireless access point 204 requiring the lowest minimal TPO value to be set to the transmitter of the mobile wireless device 202 which ensures reliable reception of messages transmitted by the transmitter by the preferred wireless access point 204.

In case there is a single wireless access point 204 within the transmission range of the transmitter of the mobile wireless device 202, the mobile wireless device 202 may naturally select this single wireless access point 204 as the preferred wireless access point 204. As described herein before, the minimal TPO value computed by the mobile wireless device 202 for this single wireless access point 204 may be the minimal TPO value computed according to the distance computed between the first geolocation (current location of the mobile wireless device 202) and the second geolocation of the single wireless access point 204. However, in case the mobile wireless device 202 determined that one or more obstacles may block at least partially the LOS transmission path to the single wireless access point 204, the minimal TPO value may be the adjusted level increased to overcome the transmission degradation induced by the blocking obstacle(s)

In case there are multiple wireless access points 204 within the transmission range of the transmitter of the mobile wireless device 202, the mobile wireless device 202 may naturally select the preferred wireless access point 204 to be the wireless access point 204 requiring the lowest minimal TPO value as computed in step 108 of the process 100.

If proximity attributes relating to obstacles information are unavailable to the mobile wireless device 202 or no obstacles are identified to block the transmission paths to any of the in-range wireless access points 204, the minimal TPO value is computed by the mobile wireless device 202 strictly according to the distance between the first geolocation and the second geolocation of each of the in-range wireless access points 204 as described in step 108 of the process 100. The selected preferred wireless access point 204 in such case may typically be the wireless access point 204 which is nearest to the mobile wireless device 202, i.e. the shortest distance wireless access point 204.

However, there may be cases in which proximity attributes relating to obstacles information are available to the mobile wireless device 202 for one or more obstacles which may block at least partially the LOS transmission path to one or more of the in-range wireless access points 204. In such cases, the mobile wireless device 202 may select the preferred wireless access point 204 based on aggregation of the distance to each of the in-range wireless access points 204 and the transmission degradation induced by the clocking obstacles to transmission transmitted by the transmitter of the mobile wireless device 202 to the respective in-range wireless access point 204. In particular, the mobile wireless device 202 may select the preferred wireless access point 204 to be the wireless access point 204 having a lowest minimal aggregated TPO value.

The mobile wireless device 202 may compute the minimal aggregated TPO value for each of the in-range wireless access points 204 by computing the minimal TPO value according to the distance to between the first geolocation and the second geolocation of the respective in-range wireless access point 204 adjusted (increased) to overcome the degradation induced by the obstacles blocking the LOS transmission path to the respective wireless access point 204. After computing the minimal aggregated TPO value for each of the in-range wireless access points 204, the mobile wireless device 202 may select the wireless access point 204 having the lowest minimal aggregated TPO value as the preferred wireless access point 204.

As shown at 112, the mobile wireless device 202 may adjust the TPO of its transmitter according to the minimal TPO value computed for the preferred wireless access point 204 to set the TPO to the minimal value which is sufficient for the preferred wireless access point 204 to reliably receive messages transmitted by the mobile wireless device 202. As described herein before, the minimal TPO value may be the level computed based on the distance between the mobile wireless device 202 and the preferred wireless access point 204 or it may be the minimal aggregated TPO value computed for the preferred wireless access point 204 to overcome obstacle(s) determined to block at least partially the LOS transmission line of the transmitter to the preferred wireless access point 204,

Setting the TPO to the minimal value required for reliable transmission may significantly reduce the power consumption of the transmitter compared to transmission with full strength TPO which may be superfluous in many cases, for example, when the mobile wireless device 202 is relatively close to the wireless access point 204 and/or when a direct LOS transmission path between the mobile wireless device 202 and the wireless access point 204 is available and clear of obstacles. As the transmitter may be one of the major power consumers of the mobile wireless device 202, reducing the transmitters power consumption may significantly reduce the overall power consumption of the mobile wireless device 202 and may thus significantly increase battery life of the mobile wireless device 202.

Optionally, the mobile wireless device 202 adjusts the TPO of its transmitter to increase the TPO value to a higher level than the minimal TPO value in order to ensure reliable transmission to the preferred wireless access point 204. Specifically, the mobile wireless device 202 may increase the TPO to overcome one or more transmission degradation effects which may result from, for example, environmental conditions (e.g. temperature, humidity, precipitation, etc.), obstacles along the LOS transmission path, electromagnetic interferences and/or the like. The mobile wireless device 202 may increase the minimal TPO value according to one or more predefined settings and/or rules. For example, according to the predefined setting(s), the mobile wireless device 202 may increase the TPO by 5% above the minimal value. The settings and/or rules predefined for the TPO may further dictate the TPO according to one or more characteristics and/or attributes of the transmission environment 200 in which the mobile wireless device 202 is located. For example, according to the predefined setting(s), the mobile wireless device 202 may increase the TPO by 5% above the minimal value when located in open area where no obstacles are blocking the direct LOS transmission path between the mobile wireless device 202 and the wireless access point 204. In another example, according to the predefined setting(s), the mobile wireless device 202 may increase the TPO by 10% above the minimal value when located in an urban area where the wireless transmission may be degraded. Wireless transmission degradation may result due to one or more conditions of the urban area, for example, obstacle(s) blocking the transmission path, multipath effects induced by reflections and deflections of the transmitted signal off objects (e.g. walls, buildings, etc.), increased electromagnetic interference (due to presence of radiation emitting devices) and/or the like.

The mobile wireless device 202 may continuously and/or periodically repeat the process 100 to dynamically adjust the transmitter's TPO value as the mobile wireless device 202 moves and thus changes its location with respect to the wireless access point 204 deployed in the transmission environment 200.

As the mobile wireless device 202 moves in the transmission environment 200 new geolocation data is received. The mobile wireless device 202 may analyze the newly received geolocation data and, executing the process 100, may adjust the TPO value according to one or more changes of the first geolocation identified by the analysis of the new geolocation data.

For example, as seen in the exemplary wireless environment 200, assuming the mobile wireless device 202 is located at geolocation GL1_1 and moves to the geolocation GL1_2. Assuming D1_1 is shorter than D1_2 and D2_1 is shorter than D2_2 and no obstacles are located between the geolocations GL1_1 and GL_2 and the geolocation GL2A, the mobile wireless device 202 may select the wireless access point 204A as the preferred wireless access point when located in both geolocations GL1_1 and GL1_2. However, when moving from the geolocation GL1_1 to the geolocation GL1_2, the mobile wireless device 202 may dynamically adjust the TPO of its transmitter from the minimal TPO value set for the distance D1_1 to a new minimal TPO value set according to the distance D2_1 computed for the geolocation GL1_2.

Moreover, in case there are multiple wireless access points 204 in the transmission range (coverage area) of the transmitter of the mobile wireless device 202, the moving mobile wireless device 202 may dynamically adjust the minimal TPO value according to the minimal TPO value computed for a newly selected preferred wireless access point 204. For example, assuming there are no blocking obstacles in the wireless environment 200, when located at the geolocation GL1_2, the mobile wireless device 202 may select the wireless access point 204A as the preferred wireless access point 204 since D2_1 is shorter than D2_2. However, when advancing from the geolocation GL1_2 to the geolocation GL1_3, the mobile wireless device 202, based on computation of the minimal TPO value for both wireless access points 204A and 204B. may select the wireless access point 204B to be the preferred wireless access point 204. The mobile wireless device 202 may therefore adjust the TPO of its transmitter accordingly to the minimal TPO value computed according to the distance D3_2 between the (first) geolocation GL1_3 and the (second) geolocation GL2B.

It is expected that during the life of a patent maturing from this application many relevant systems, methods and computer programs will be developed and the scope of the terms mobile wireless device and wireless access points are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A mobile wireless device configured to dynamically adjust its Transmitter Power Output (TPO), comprising:
at least one circuitry configured to:
compute a first geolocation of the mobile wireless device based on geolocation data received by the mobile wireless device;
obtain a plurality of proximity attributes of at least one fixed location wireless access point, the plurality of proximity attributes comprising at least a predefined second geolocation of the respective wireless access point and obstacle information relating to at least one obstacle blocking at least partially a Line of Sight (LOS) transmission path between the mobile wireless device and the respective wireless access point;
compute a minimal TPO value for the transmitter according to a distance between the first geolocation and the second geolocation of each wireless access point located within a transmission range of a transmitter of the mobile wireless device and based on said obstacle information, the minimal TPO value is sufficient for the respective wireless access point to reliably receive each message transmitted by the transmitter;
select a preferred wireless access point from the at least one wireless access point by identifying a wireless access point requiring a lowest minimal TPO value among the computed minimal TPO values; and
adjust the TPO of the transmitter to the lowest minimal value.

2. The mobile wireless device of claim 1, wherein the geolocation data used by the circuitry to compute the first geolocation is received from at least one location sensor of the mobile wireless device.

3. The mobile wireless device of claim 1, wherein the geolocation data used by the circuitry to compute the first geolocation is extracted from a plurality of beacon messages received from a plurality of beacon transmitting devices.

4. The mobile wireless device of claim 1, wherein at least one of the plurality of proximity attributes is predefined in the mobile wireless device.

5. The mobile wireless device of claim 1, wherein at least one of the plurality of proximity attributes is received by the circuitry in at least one message transmitted by at least one wireless device configured to broadcast the second geolocation.

6. (canceled)

7. The mobile wireless device of claim 1, wherein the circuitry is further configured to adjust the minimal TPO value to overcome transmission degradation induced by the at least one obstacle.

8. The mobile wireless device of claim 7, wherein the circuitry is further configured to adjust the minimal TPO value according to selection of the preferred wireless access point based on aggregation of the distance and the transmission degradation induced by the at least one obstacle with respect to each of a plurality of wireless access points located in the transmission range of the transmitter.

9. The mobile wireless device of claim 1, wherein the circuitry is further configured to dynamically adjust the minimal TPO value according to at least one change of the first geolocation of the mobile wireless device identified according to newly received geolocation data.

10. A method of dynamically adjusting Transmitter Power Output (TPO) of a mobile wireless device, comprising:
computing a first geolocation of the mobile wireless device based on geolocation data received by the mobile wireless device;
obtaining a plurality of proximity attributes of at least one fixed location wireless access point, the plurality of proximity attributes comprising at least a predefined second geolocation of the respective wireless access point and obstacle information relating to at least one obstacle blocking at least partially a Line of Sight (LOS) transmission path between the mobile wireless device and the respective wireless access point;
computing a minimal TPO value for the transmitter according to a distance between the first geolocation and the second geolocation of each wireless access point located within a transmission range of a transmitter of the mobile wireless device and based on said obstacle information, the minimal TPO value is sufficient for the respective wireless access point to reliably receive each message transmitted by the transmitter;
selecting a preferred wireless access point from the at least one wireless access point by identifying a wireless access point requiring a lowest minimal TPO value among the computed minimal TPO values; and
adjusting the TPO of the transmitter to the lowest minimal value.

11. The method of claim 10, wherein the geolocation data used to compute the first geolocation is received from at least one location sensor of the mobile wireless device.

12. The method of claim 10, wherein the geolocation data used to compute the first geolocation is extracted from a plurality of beacon messages received from a plurality of beacon transmitting devices.

13. The method of claim 10, wherein at least one of the plurality of proximity attributes is predefined in the mobile wireless device.

14. The method of claim 10, wherein at least one of the plurality of proximity attributes is received in at least one message transmitted by at least one wireless device configured to broadcast the second geolocation.

15. (canceled)

16. The method of claim 10, is further comprising adjusting the minimal TPO value to overcome transmission degradation induced by the at least one obstacle.

17. The method of claim 16, further comprising adjusting the minimal TPO value according to selection of the preferred wireless access point based on aggregation of the distance and the transmission degradation induced by the at least one obstacle with respect to each of a plurality of fixed location wireless access points located in the transmission range of the transmitter.

18. The method of claim 10, further comprising dynamically adjusting the minimal TPO value according to at least one change of the first geolocation of the mobile wireless device identified according to newly received geolocation data.

19. A computer program product for dynamically adjusting Transmitter Power Output (TPO) of a mobile wireless device, comprising:
a non-transitory computer readable storage medium;
first program instructions to compute a first geolocation of the mobile wireless device based on geolocation data received by the mobile wireless device;
second program instructions to obtain a plurality of proximity attributes of at least one fixed location wireless access point, the plurality of proximity attributes comprising at least a predefined second geolocation of the respective wireless access point and obstacle information relating to at least one obstacle blocking at least partially a Line of Sight (LOS) transmission path between the mobile wireless device and the respective wireless access point;
third program instructions to compute a minimal TPO value for the transmitter according to a distance between the first geolocation and the second geolocation of each wireless access point located within a transmission range of a transmitter of the mobile wireless device and based on said obstacle information, the minimal TPO value is sufficient for the respective wireless access point to reliably receive each message transmitted by the transmitter;
fourth program instructions to select a preferred wireless access point from the at least one wireless access point by identifying a wireless access point requiring a lowest minimal TPO value among the computed minimal TPO values; and
fifth program instructions to adjust the TPO of the transmitter to the lowest minimal value;
wherein the first, second, third, fourth and fifth program instructions are executed by at least one processor of the mobile wireless device from the non-transitory computer readable storage medium.

20. The mobile wireless device of claim 1, wherein said obstacle information includes at least one of a description of the obstacle, a size of the obstacle, a height of the obstacle and a material composing the obstacle.

21. The mobile wireless device of claim 1, wherein said obstacle information is extracted by said mobile wireless device from one or more global proximity data sources including at least one of a map and a list, associated with one or more of said at least one access point.

22. The mobile wireless device of claim 1, wherein said at least one circuitry is further configured to dynamically re-select another preferred wireless access point according to a change in said computed minimal TPO values.
